(19) United States
(12) Patent Application Publication
(10) Pub. No.: US 2012/0209668 A1
(43) Pub. Date: Aug. 16, 2012

(54) DYNAMICALLY SERVING CONTENT TO SOCIAL NETWORK MEMBERS

(76) Inventors: Terry Angelos, Mountain View, CA (US); Eddie Lim, Palo Alto, CA (US); Robert DiMarco, Stanford, CA (US); Vickie Wong, Sunnyvale, CA (US); Alexander E. Campbell, San Jose, CA (US); Alastair Rampell, Palo Alto, CA (US); Arjuna Wijeyekoon, South San Francisco, CA (US); Gyuchang Jun, Sunnyvale, CA (US)

(21) Appl. No.: 13/027,819

(22) Filed: Feb. 15, 2011

(51) Int. Cl. G06F 15/16; G06Q 30/00

(52) U.S. Cl. 705/14.1; 709/204; 705/14.53

(57) ABSTRACT

From a third-party process within a social network having a platform policy, a graph of a social network member is queried. The results of the query are passed to a matching process, without violating the platform policy. Content is requested from the process. In response to passing the results, a description of content is received. The content is caused to be made available to the social network member.

### TECHNICAL FIELD

This document relates to making content available to members of a social network.

### BACKGROUND

A graph is a collection of nodes and edges that connect some pairs of nodes. A social graph in which each node represents a person, and two nodes are connected when the corresponding people share a particular social relationship. For example, such social relationships may include being family members, being friends, doing or having done business together, etc.

A social network is a computer-based platform for conducting various activities pertinent to a social graph. For example, on many social networks, users can send and receive messages with their contacts, play games with their contacts, etc. Moreover, the social network often stores additional information pertinent to a particular node (e.g., the corresponding person's age, gender, location, etc.)

### SUMMARY

In general, in one aspect, from a third-party program within a social network having a platform policy, querying a social graph of a social network member; passing results of the query to a matching process without violating the platform policy, thereby requesting content from the process; in response to passing the results, receiving a description of content; and causing the content to be displayed to the social network member.

Aspects may include one or more of the following features: Querying the social graph includes retrieving a characteristic of the social network member. The characteristic of the social network member include at least one of: a location of the member, an income level of the member, a birth date of the member, a gender of the member, an income level of the member, a marital status of the member, hobbies of the member, interests of the member, a transaction history of the member, and an anniversary of the member. The characteristic of the social network member includes a virtual currency balance. The characteristic of the social network member includes previous interaction with other third-party programs on the social network. Querying the social graph includes retrieving a characteristic of connections of the social network member. The content is displayed dynamically within the gaming environment. The content includes an advertisement. The content is interactive. The content includes an offer to purchase an item, thereby obtaining an ancillary benefit. The ancillary benefit includes virtual currency usable in an in-game environment. The ancillary benefit includes access to premium services of a provider. Additionally providing a social game to the social network member, in which querying the social graph is performed in response to a pre-determined in-game event. Additionally, prior to causing the content to be displayed, defining an in-game area in which the content is to be displayed. The in-game event includes the social network member initiating gameplay. The in-game event includes the social network member initiating an in-game transaction.

Other aspects include other combinations of the features recited above and other features, expressed as methods, apparatus, systems, program products, and in other ways. Other features and advantages will be apparent from the description and from the claims.

### DESCRIPTION OF DRAWINGS

Embodiments of the invention described herein may be understood by reference to the following figures, which are provided by way of example and not of limitation:

FIG. 1 is a schematic depiction of dynamically providing content to a social network user through a third-party process.

FIGS. 2A-C are exemplary screenshots of dynamically provided content

FIG. 3 is a flowchart for displaying content from within a third-party process.

FIG. 4 is a flowchart for matching content with user characteristics.

Like references numbers refer to like structures.

### DETAILED DESCRIPTION

When a user registers with a social network, the user typically provides the social network with certain personal information, such as demographic information (e.g., date of birth, location, gender, etc.), contact information (e.g., e-mail address, phone number, etc.), and other personal information. Moreover, additional information can be learned from a user's conduct in the social network environment (e.g., commercial preferences can be inferred from interaction with advertisements, social relations can be inferred by the user's developing social graph, etc.).

Many social networks permit third parties to develop and deploy suitable programs for use within the social network. Such programs include, for example, social games, utilities, and the like. For some social networks, a program is only “suitable” if it complies with a platform policy established by the social network to protect users' personal information, and/or the social network's proprietary information about its users. In this document, “platform policy” is a general term describing who or what is allowed to access any information maintained by the social network, who or what may communicate with users or third parties, what content may be communicated to whom and under what circumstances, who or what may execute particular functions within the social network, and the manner in which any of the above is carried out. In particular, the phrase “platform policy” is meant to include privacy policies, security policies, applications policies, terms of service, communication policies (including adult content policies), advertising policies, developer guidelines, and the like.

For example, some privacy policies permit a third party application to retrieve information about a user, the user's social graph, and the user's behavior in the social network environment. Some privacy policies forbid third-party applications from re-transmitting such information outside of the social-network environment.

However, such information is often useful in providing targeted content to a particular user. For example, in the context of advertising, advertisements that are of high interest to an eighteen-year-old male in a large, densely populated city may not be high interest to an eighty-year-old female in a rural community.

The techniques described below permit one to dynamically present, from outside the social network, content specifically targeted to social network members, while respecting typical privacy policies of popular social networks.

In this document, a thing (such as a computer, a process, etc.) is said to be “within” a social network when it has access to at least some non-public information about at least one user of the social network. In particular, a process can be “running within” a social network even though the physical hardware components on which the process runs is not the same as the physical hardware components that support the social network itself. A thing that is not within the social network is said to be outside the social network.

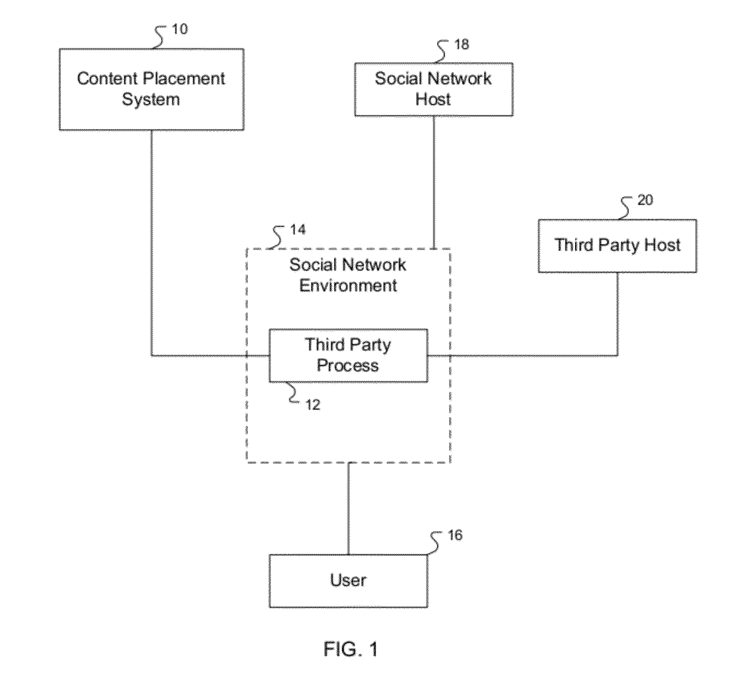

FIG. 1 is a schematic depiction of a dynamically presenting content to a social network user through a third-party process. In FIG. 1, a content placement system 10 is in data communication with a third-party process 12 running within a social network environment 14. A user 16 interacts with the social network environment 14, undertaking such activities as communicating with contacts, playing games, shopping, etc. The social network environment 14 is a collection of one or more programs running on one or more social network hosts 18, while third-party processes 12 within the social network environment are collections of one or more programs running on one or more third-party hosts 20.

Although only one of certain components (third-party process 12, social network environment 14, user 16, social network host 18, third-party host 20) are shown, multiple such components can be simultaneously engaged with one or more social network environment 14, and can be provided with dynamic content from a single content placement system 10. Similarly, several such content placement systems 10 can be simultaneously used in a single social network environment 14 or by a single third-party process 12.

In some implementations, the content placement system includes functionality to target content to particular users. Continuing an example described above, the content placement system 10 can be configured to serve one group of advertisements to eighteen year old males in large, densely populated cities, and another group of advertisements to eighty year old females in rural areas. As described more fully below, the content placement system 10 can be configured to provide targeted content based at least in part on virtually any characteristic of a user, not just gender, age, or location.

Examples of third-party processes include (but are not limited to) social games and social utilities (e.g., shared calendars, instant message utilities, location-based utilities, etc.). The phrase “third party” connotes that the process is not an integral part of the social network environment 14. For example, independent developers can develop third-party processes.

As described more fully below, the third party process 12 is configured to provide the content placement system 10 with sufficient information to identify targeted content that can be displayed by the third party process to a user, all while respecting the platform policy of the social network.

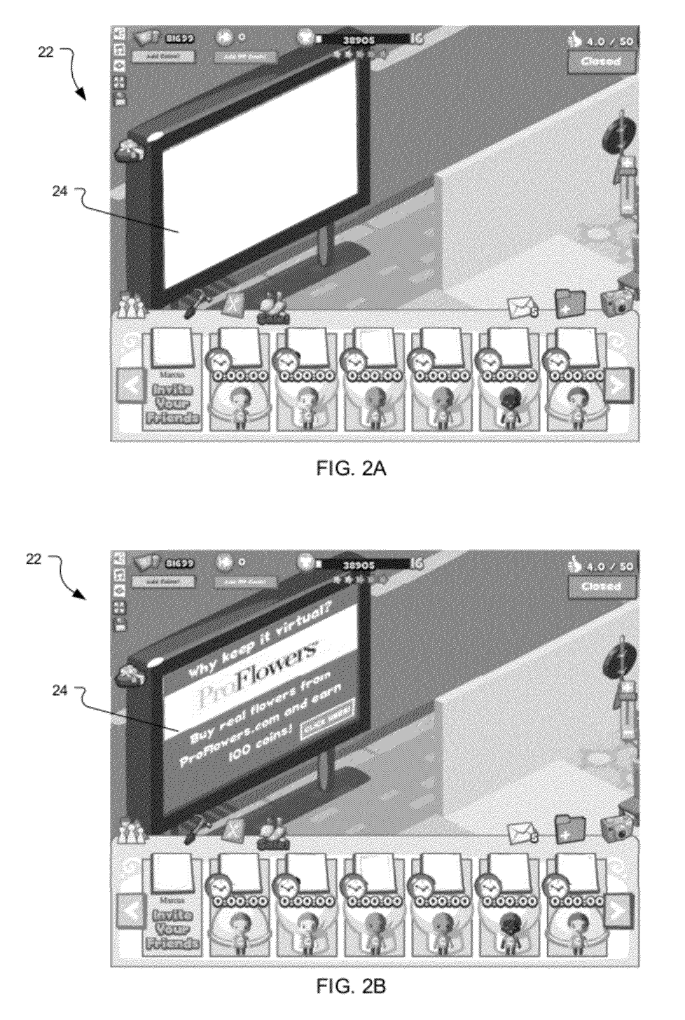

FIGS. 2A-C are exemplary screenshots of dynamically provided content.

In FIG. 2A, an exemplary scene of a third-party process is shown. In this case, the exemplary third-party process 12 is a game in which users mutually interact with each other in an in-game environment 22. For example, the in-game environment in FIGS. 2A-2C simulates a town. Pre-determined content spaces 24 are found at various locations within the in-game environment 22. For example, in FIG. 2A, a content space 24 is meant to simulate a billboard. Note that in FIG. 2A, there is no content presented in the content space.

As described more fully below, content can be retrieved from a remote location and presented dynamically to a user. Here, “dynamically” means that the content need not be determined or identified at any time except immediately prior to its display. (E.g., the content need not be determined or identified when the third-party process 12 begins, when a user logs in, etc.)

FIG. 2B depicts the same exemplary scene in the third-party process, except with content displayed in the content space 24. In the example of FIG. 2B, the content includes an advertisement informing the user of a sale on flowers. FIG. 2C depicts the same exemplary scene as FIG. 2B, except instead of an advertisement for flowers, the content space 24 includes an advertisement for concert tickets for a particular band.

As described more fully below, the determination of whether to display an advertisement for concert tickets vs. flowers can be based at least in part on various characteristics of the user. For example, if the user has indicated to the social network that his anniversary is in the near future, then that may be pertinent to deciding to display the flowers advertisement. Similarly, if the user is a member of various groups associated with the band performing at the concert, this information may be pertinent in deciding to display the concert advertisement.

In general, the content can be provided or displayed in any format. For example, the content can include pictures, animations, movies, sound, etc. The content may also include source code or executable programs that determine how the content behaves in the third-party program environment, or how users in the environment can interact with the content. For example, the content can include: a “virtual store” that sells various in-game products; an artificially intelligent in-game character that interacts with passing users in a prescribed way; or many other examples.

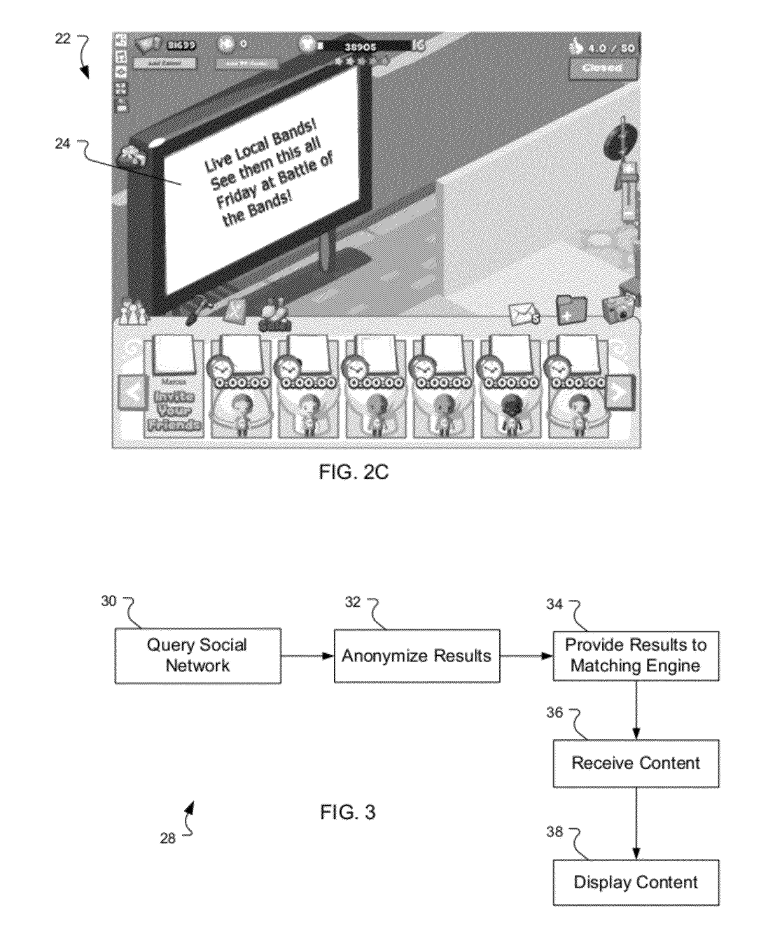

FIG. 3 is a flowchart for displaying content within a third-party process. The display process 28 begins with the third-party process querying the social network (step 30). The specific nature of the query can depend on the particular goals of the parties involved (e.g., the goals of the third-party process provider, the content placement system operator, content providers, or other parties). The nature of the query can also be limited by the privacy policies of the social network. The query can be performed in response to any pre-determined event. For example, a pre-determined event can include the user initiating the third-party process (e.g., starting a game). The pre-determined event can include any other event within the third-party process, such as initiating an in-game transaction or undertaking any other in-game activity. As a result of the query, the third-party process retrieves one or more characteristics of a user, the user's behavior, or other contextual information.

In some implementations, the query retrieves information that is not restricted by the platform policy of the social network. For example, the query could retrieve an Internet Protocol (“IP”) address of the user, the type of operating system or web browser the user is running, or other non-personal information.

In some implementations, the query retrieves information that is restricted by the platform policy of the social network. For example, this may include: the user's demographic information (e.g., birthday, gender, vital statistics, home location, current location, income, employment status, marital status, anniversary, hobbies, interests, etc.); information about the user's social graph (e.g., number of connections, membership in various groups, etc.); behavior within the social network (e.g., whether and to what extent the user interacts with various aspects of the social network, including other third-party programs or advertisements; the frequency or other use patterns with which a user logs on to the social network, etc.); the user's status in a particular third-party program (e.g., in a social game, the user's score, level, health, inventory, virtual currency balance, access or availability of resources, etc.), and other characteristics. Moreover, the query may also retrieve these characteristics of others members in the user's social graph besides the user himself. In some implementations, the results of the query are then anonymized (step 32). Depending on the social network's platform policy, the third-party process 12 may export some personal data of users outside the social network environment 14, so long as other personal data is not also provided. For example, under some privacy policies, it may be permissible to export some demographic information of a user, so long as there is no information that can be used to individually identify the user (e.g., the user's name, address, etc.). In this case, anonymizing the results of the query constitutes removing those characteristics that cannot be exported outside the social network environment 14.

In step 34, the results of the query are provided to a matching engine. As described more fully below, the matching engine is a module operable to match the characteristics of the user with appropriate content, and identify that content to the third-party process. In some implementations, the matching engine is implemented in whole or in part outside the social network; e.g., on the content placement system 10. In some cases, the matching engine is implemented in whole or in part within the social network; e.g., within the third-party process 12. For social networks with strict security policies, implementing the matching engine within the third-party process allows the matching engine to use all the available characteristics obtained from the query in deciding what content to display. Consequently, this can result in more effectively matching content with users who may find the content useful.

In step 36, the content description is received from the matching engine by the third party process. The content description can include the actual content itself. Alternatively, the content description can simply include a location at which the content resides. This location can be anywhere; e.g., on the social network host 18, on the third party host 20, on the content placement system 10, or on some other data storage medium (such as on a server controlled by an advertiser).

In step 38, the content is then displayed to the user from within the third party process. In some implementations, the content is displayed in a pre-defined content space 24, although in general the content need not be displayed in such a space. In some implementations, displaying content includes calling a pre-existing content player capable of presenting the particular format the content is in. In some implementations, displaying the content may involve compiling source code, rendering markup language, or executing one or more programs.

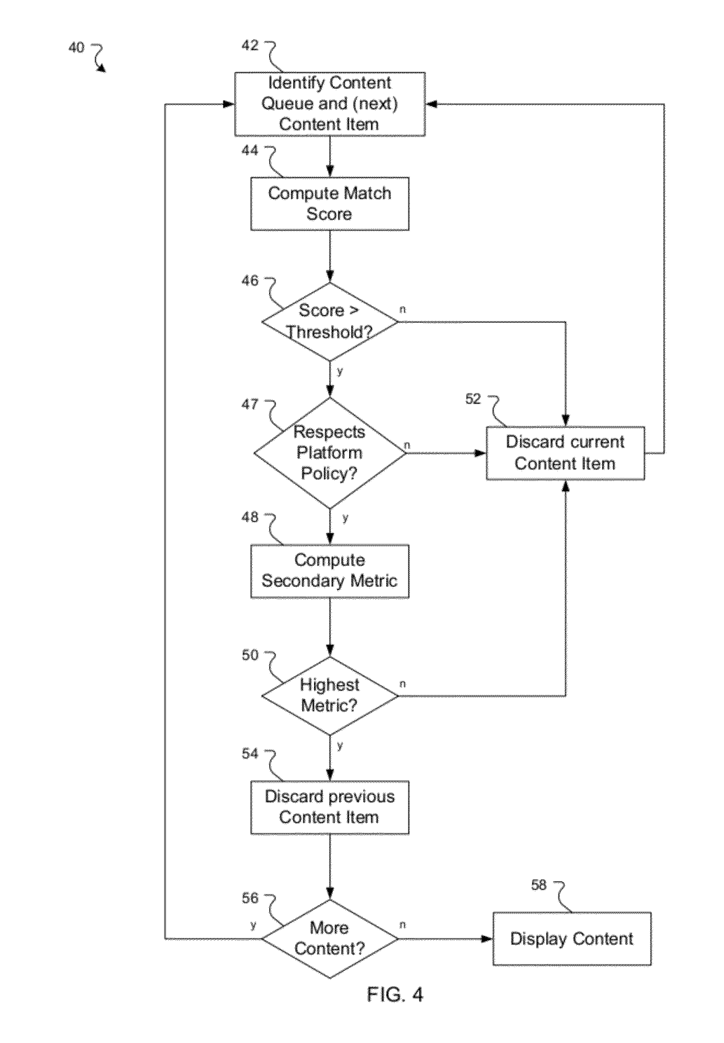

FIG. 4 is a flowchart for matching content with user characteristics. In some implementations, the matching process 40 is performed by the matching engine. In step 42, a content queue is identified and a content item is identified in the queue. In some implementations, the content queue may be maintained by the content placement system 10.

In some implementations, a content provider (e.g., an advertiser) engages a proprietor of the content placement system 10 to include one or more content items in the content queue, in exchange for a fee. The content provider specifies one or more desired characteristics of a user to whom the content is displayed. The content provider may also specify relative weights with which to accord the various characteristics, and other such information pertinent to ranking how well a particular set of user characteristics meets the desired set of characteristics. Additionally, the content provider may specify desired conditions extrinsic to the user (e.g., the time until a holiday or other important event) that are also pertinent in such ranking.

A matching score is computed for the identified content item (step 44). The matching score can be computed by any formula, and reflects how well a particular set of user characteristics meets the set of characteristics desired by the content provider. For convenience and for purposes of illustration, it will be assumed that a higher score reflects a better match, although in general this need not be the case.

In decision 46, the matching process 40 determines whether the matching score for the identified content item is above a pre-determined threshold. If a threshold is not desired, in some implementations the threshold can be set to zero (or more generally, it can be set to the lowest possible matching score for whatever formula is selected.) If the matching score is not above the pre-determined threshold, then the content item is discarded (step 52) and the next content item is selected from the queue (step 42).

If the matching score is above the pre-determined threshold, then decision 47 determines whether the content item can be made available to the user while respecting the platform policy of the social network. For example, platform policies may prohibit: making content available to users below a pre-determined age, making certain content available to users who have expressly requested not to receive that type of communication, etc. If making the content item available to the user would violate the platform policy, that content item is discarded (step 52).

If making the content item available to the user respects platform policies, then a secondary metric is computed with respect to the content item (step 48). In some implementations, a secondary metric measures an economic property of displaying the content item (e.g., the cost to the content provider, the profit to the content placement system proprietor, the profit to the third-party process provider, etc), or the required consumption of a resource to display the content item (e.g., the required bandwidth to deliver the content item, the required processing power to compile or render the content item, etc.). The matching score itself can also be used as a secondary metric. Other secondary metrics can be used, including combinations of the foregoing. Alternatively if a secondary metric is not desired, steps 48 and 50 can be ignored, and control can pass directly to step 58. Conversely, although FIG. 4 refers only to “a” secondary metric, several different metrics can be computed and used together in order to determine which content item to make available.

In decision 50, it is determined whether the secondary metric of the identified content item is better than the previously-identified content item. In some embodiments, “better” means greater than (e.g., when the secondary metric reflects profits or a matching score). In some embodiments, “better” means less than (e.g., when the secondary metric reflects costs or resource consumption). If the secondary metric is better than the previously-identified content item, the previously-identified content item is discarded. (Step 51). If the secondary metric is not better than a previously-identified content item, the currently-identified content item is discarded (step 52).

If more content is available in the queue (decision 54), then the next content item is identified as control returns to step 42. If no more content is available in the queue, then the currently-identified content item is made available to the user (step 56).

While the foregoing drawings and description set forth functional aspects of the disclosed systems, no particular arrangement of software and/or hardware for implementing these functional aspects should be inferred from these descriptions unless explicitly stated or otherwise clear from the context, and all such arrangements of software and/or hardware are intended to fall within the scope of this disclosure.

Many of the above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

In embodiments, disclosed herein are computer program products comprising computer-executable code or computer-usable code that, when executing on one or more computing devices (such as the devices/systems described above), performs any and/or all of the steps described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the processes described above may be embodied in any suitable transmission or propagation medium carrying the computer-executable code described above and/or any inputs or outputs from same.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the invention(s) described herein are intended to include any suitable method of causing one or more other parties or entities to perform the steps consistent with the patentability of the following claims, unless a different meaning is expressly provided or otherwise clear from the context. Such parties or entities need not be under the direction or control of any other party or entity, and need not be located within a particular jurisdiction. Thus for example, a description or recitation of “adding a first number to a second number” includes causing one or more parties or entities to add the two numbers together. For example, if person X engages in an arm's length transaction with person Y to add the two numbers, and person Y indeed adds the two numbers, then both persons X and Y perform the step as recited: person Y by virtue of the fact that he actually added the numbers, and person X by virtue of the fact that he caused person Y to add the numbers. Furthermore, if person X is located within the United States and person Y is located outside the United States, then the method is performed in the United States by virtue of person X's participation in causing the step to be performed.

While the invention has been disclosed in connection with certain embodiments, other embodiments are possible and will be recognized by those of ordinary skill in the art. All such variations, modifications, and substitutions are intended to fall within the scope of this disclosure. Thus, the invention is to be understood with reference to the following claims.

What is claimed is:

1. From a third-party process within a social network having a platform policy, a method comprising:
querying a social graph of a social network member;
passing results of the query to a matching process without violating the platform policy, thereby requesting content from the process;
in response to passing the results, receiving a description of content; and
causing the content to be made available to the social network member.

2. The method of claim 1, wherein querying the social graph includes retrieving a characteristic of the social network member.

3. The method of claim 2 wherein the characteristic of the social network member include at least one of: a location of the member, an income level of the member, a birth date of the member, a gender of the member, an income level of the member, a marital status of the member, hobbies of the member, interests of the member, a transaction history of the member, and an anniversary of the member.

4. The method of claim 2, wherein the characteristic of the social network member includes a virtual currency balance.

5. The method of claim 2, wherein the characteristic of the social network member includes previous interaction with other third-party programs on the social network.

6. The method of claim 1, wherein querying the social graph includes retrieving a characteristic of connections of the social network member.

7. The method of claim 1, wherein the content is displayed dynamically within the gaming environment.

8. The method of claim 1, wherein the content includes an advertisement.

9. The method of claim 1, wherein the content is interactive.

10. The method of claim 1, wherein the content includes an offer to purchase an item, thereby obtaining an ancillary benefit.

11. The method of claim 10, wherein the ancillary benefit includes virtual currency usable in an in-game environment.

12. The method of claim 10, wherein the ancillary benefit includes access to premium services of a provider.

13. The method of claim 1, further comprising providing a social game to the social network member, in which querying the social graph is performed in response to a pre-determined in-game event.

14. The method of claim 13, further comprising, prior to causing the content to be displayed, defining an in-game area in which the content is to be displayed.

15. The method of claim 13, in which the in-game event includes the social network member initiating gameplay.

16. The method of claim 13, in which the in-game event includes the social network member initiating an in-game transaction.

17. The method of claim 13, in which the in-game event includes the social network member visiting an in-game environment of a connection in the social network member's social graph.
